(19) United States
(12) Patent Application Publication
(10) Pub. No.: US 2007/0008824 A1
(43) Pub. Date: Jan. 11, 2007

(54) Watch

(75) Inventor: Francis Cretin, Bois-D'Amont (FR)

Correspondence Address: YOUNG & THOMPSON, 745 SOUTH 23RD STREET, 2ND FLOOR, ARLINGTON, VA, 22202, US

(73) Assignee: RICHEMONT INTERNATIONAL S.A., VILLARS-SUR-GLANE (CH)

(21) Appl. No.: 11/481,890

(22) Filed: Jul. 7, 2006

(30) Foreign Application Priority Data
Jul. 8, 2005 (CH) 01143/05

(51) Int. Cl. G04C 19/00; G04C 21/00

(52) U.S. Cl. 368/69

(57) ABSTRACT

The watch comprises a case (9) with a fixed part (10) in the shape of a bracket (20) and a mobile part (11) with a middle (21) and a movement (23) mounted onto the fixed part (10) so as to be able to swivel about a swivel axis (32) thanks to pivots (31) in order to realise a tilting motion of the mobile part (11) in two opposite directions. Two actuating mechanisms (44, 45) are mounted into the middle (21) and intended to transform the tilting motions into an action upon two control organs of functions of the movement that may be of the chronograph type. One thus obtains a watch without push-pieces, functioning precisely, having great stability and easy manipulation.

The present invention refers to a watch comprising a case and a movement fitted with at least one control organ that is accessible from outside the movement and intended for activating at least one function.

Watches of this type are known, and for instance offer the functions of start and stop and of zero reset of a chronograph watch. These watches generally have push-pieces protruding from the side of the watchcase, generally at two hours and at four hours.

These push-pieces make the watch generally bulkier and have the drawback of being elements to get caught at. They are not very comfortable to manipulate, above all for users wearing gloves. Their protruding shape may make them unpleasant to wear and produce a massive, not very aesthetic look. In addition, it is difficult to garantee their protection against the entry of water and dirt, particularly when manipulating the push-pieces in a humid or polluting atmosphere.

It is the aim of the invention to remedy these drawbacks and create a watch without visible external push-pieces in which the functions integrated into the movement, such as the chronograph functions, may be activated very easily even while wearing gloves, and in which the function controls work in a well defined, highly precise manner while having a solid construction and long life. To that end, the watch according to the invention comprises the characteristics appearing in claim 1, in that the case comprises a fixed part and a mobile part that is mounted on the fixed part so as to be able to swivel about a swivel axis, thanks to at least one pivot in order to realise a tilting motion of the mobile part relative to the fixed part, while at least one actuating mechanism cooperates with the fixed and mobile parts in order to transform the tilting motion of the mobile part into an action upon said at least one control organ, the tilting motion being realised by pressing at least one segment of the mobile part.

Owing to these characteristics, the external push-pieces are suppressed, activation of the controls of functions of the movement is facilitated even when wearing gloves. The characteristics claimed make possible a construction that is very solid and long-lived, and functions precisely owing to a tilting motion about a given swivel axis while conferring great wearing comfort und an aesthetic look.

Advantageously, the movement comprises a first and a second control organs accessible from outside and intended for activating at least a first and a second functions such as the start/stop and zero-reset functions of a chronograph, the watch including two actuating mechanisms of which a first one and a second one are arranged so as to be activated by the first and second control organs, respectively, when the mobile part performs a tilting motion in a first direction or second direction opposite to the first direction, respectively.

These characteristics yield a very precise control of at least two function controls, particularly the functions of a chronograph watch.

According to a favourable embodiment, the fixed part comprises a bracket consisting of two horn pieces and a frame that is provided with two diametrically opposite pivot segments intended to cooperate with the mobile part in order to make possible its tilting motion in two opposite directions.

The construction thus obtained is particularly reliable and offers enhanced stability and longevity.

The mobile part advantageously comprises a middle pivoted on the bracket through the two pivot pieces, this middle surrounding the movement while it is tighly sealed by a bottom below, and a bevel and crystal above.

Owing to these characteristics, one gains a highly compact and sturdy construction while profiting from an unexpected shock resistance.

In a preferred embodiment, said at least one actuating mechanism is mounted into the middle and comprises at least a first element cooperating with the bracket and linked to at least a second element cooperating with said at least one control organ of the movement.

These characteristics yield a highly precise functioning, robust construction, and facilitated assembly.

Favourably, the watch comprises selection means mounted in a mobile fashion on the mobile part and intended to inhibit a tilting motion of the mobile part in said first and/or second direction while it takes up at least one predetermined position.

One thus can inhibit any undesired activation of a control function.

Advantageously, the selection means comprise a slide mounted in mobile fashion onto the middle and including a face intended to cooperate with at least one segment of the bracket, said face and segment being shaped so as to allow, either a tilting motion of the mobile part in two opposite directions in a first position of the slide, or a tilting motion of the mobile part in a single direction in a second position of the slide, or no tilting motion of the mobile part in a third position of the slide.

Other advantages will become apparent from the characteristics expressed in the dependent claims and from the description setting forth hereinafter the invention in greater detail with the aid of drawings representing schematically and in exemplary fashion an embodiment.

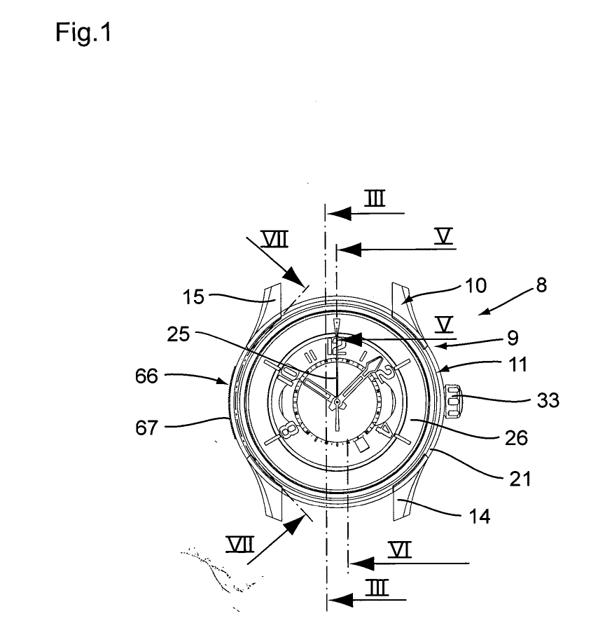

FIG. 1 is a plan view of this embodiment in the form of a chronograph without push-pieces.

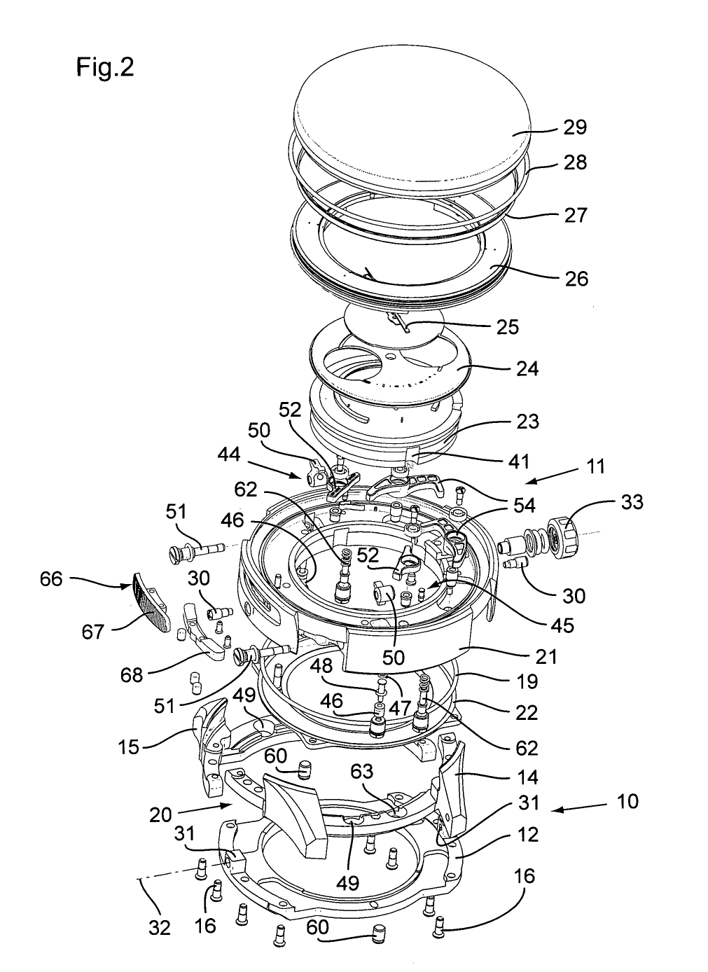

FIG. 2 is an exploded view of this chronograph.

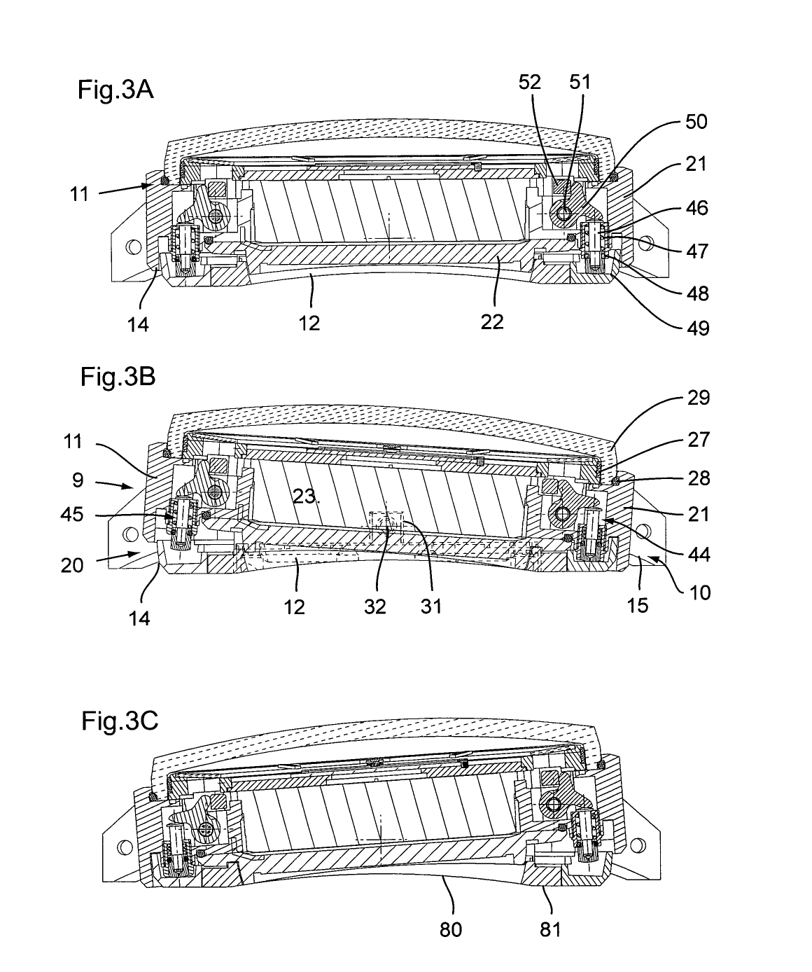

FIGS. 3A, 3B, 3C are sectional views along line III-III of FIG. 1 showing the chronograph in a rest position 3A, in a position of start/stop control 3B, and in a position of zero reset 3C.

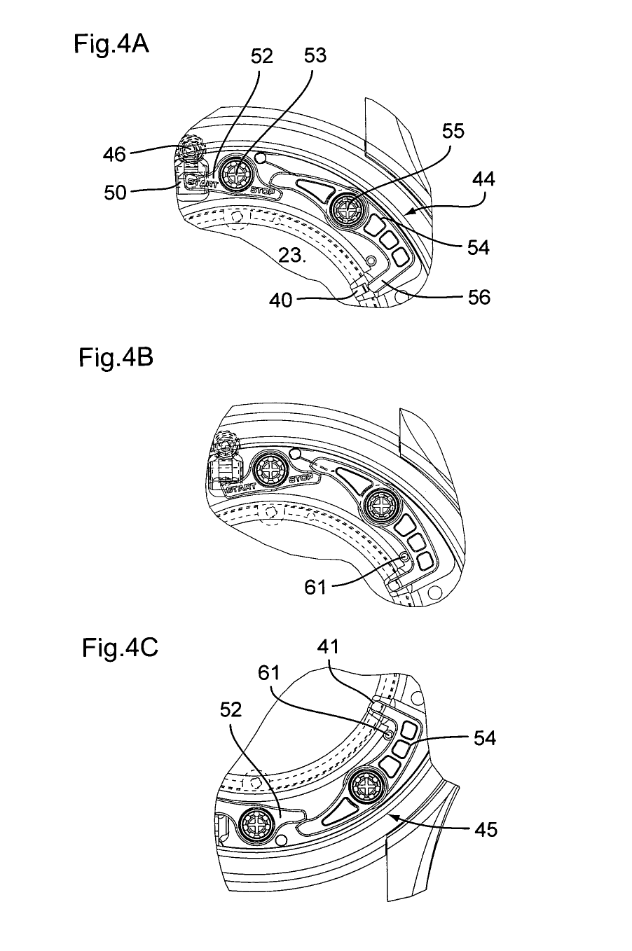

FIGS. 4A, 4B und 4C are plan views of details of the chronograph in the positions of rest 3A, start/stop control 3B, and zero reset 3C.

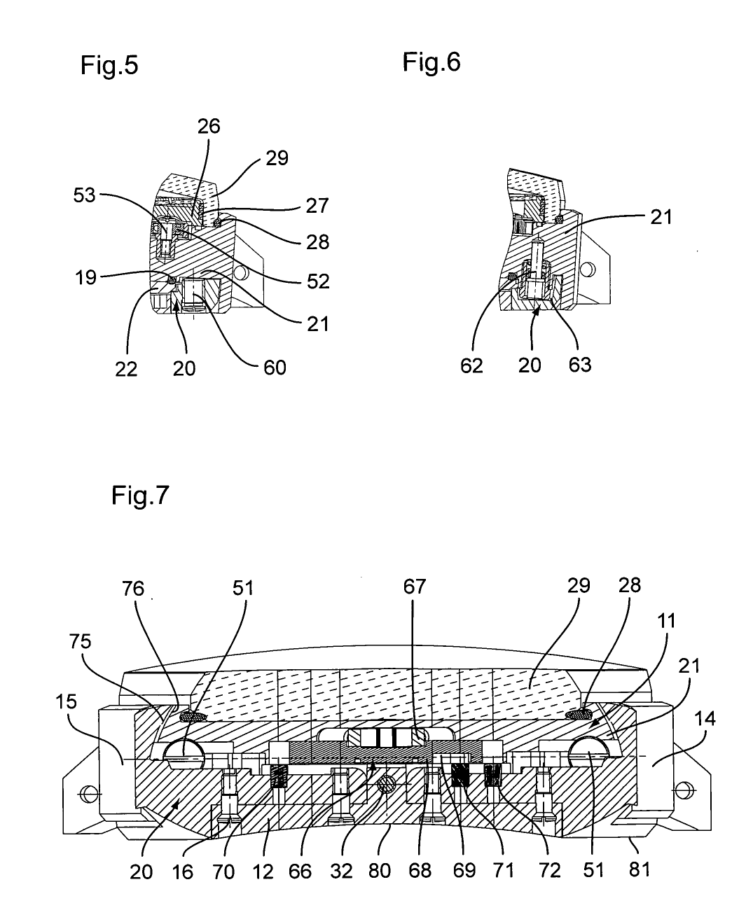

FIGS. 5 and 6 are sectional views along lines V-V and VI-VI of FIG. 1 showing details.

FIG. 7 is a sectional view along the line VII-VII of FIG. 1 and represents the selection means.

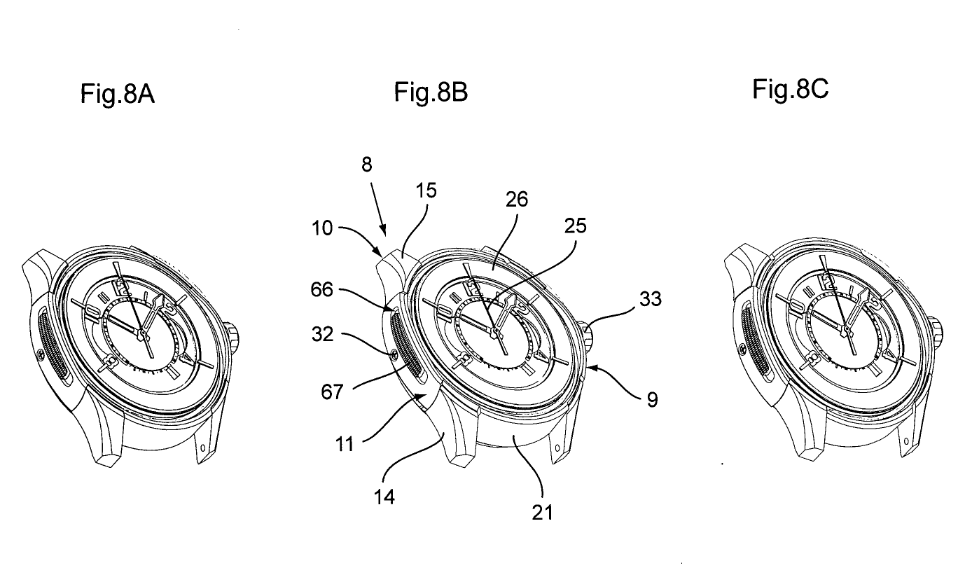

FIGS. 8A, 8B and 8C are views of this embodiment in the positions of rest 8A, start/stop control 8B, and zero reset 8C.

The embodiment illustrated in the figures consists of a chronograph-type watch. This chronograph 8 comprises a watchcase 9 including a fixed part 10 and a mobile part 11 mounted so as to swivel about the fixed part 10. Referring to FIG. 2, said fixed part consists of a frame 12 and two horn segments 14, 15 attached to frame 12 by screws 16 so as to form a bracket 20 intended to hold the mobile part 11.

This mobile part 11 comprises a middle 21 sealed off below by a screwed bottom 22 with gasket 19.

The following elements are mounted into the middle, and can be seen in FIG. 2 from bottom to top: a movement 23, a dial 24, indicating organs 25, an inner bezel 26 screwed onto the middle, a collar 27 made of plastic, a sealing gasket 28 for the crystal, and a crystal 29, as well as a crown 33 of customary design.

The middle 21 is mounted pivotingly onto the bracket 20 through two screws 30 intended to cooperate with two pivot segments 31 provided on frame 12 in the positions of 3 hours and 9 hours. By pressing the upper side of the mobile part 11 at 12 hours or at 6 hours one obtains a tilting motion of the mobile part 11 relative to the fixed part 10 following a swivel axis 32 defined by the central axis of the two screws 30 and of the two pivot segments 31.

The movement 23 comprises two control organs 40, 41 (FIG. 4) accessible from outside the movement, and intended to activate at least two functions, here the, functions of start/stop and of zero reset of the chronograph. These control organs are arranged in the traditional way at 2 hours and at 4 hours.

For an activation of these two functions, the watch is provided with two identical actuating mechanisms 44, 45 cooperating with the fixed and mobile parts 10, 11 in order to transform the tilting motion of the mobile part 11 into an action upon either of the control organs 40, 41.

The two actuating mechanisms 44, 45 are mounted into the middle 21, each comprising a piston 46 (FIGS. 3A, 3B) mounted slidingly and sealingly into the middle 21 and provided with a spring 47 and a sealing gasket 48. The lower end of piston 46 cooperates with a recess 49 provided in the bracket 20, while the head of piston 46 is in contact with a first intermediate wheel 50 mounted rotatably about a screw 51 set horizontally into the middle 21.

This first intermediate wheel 50 acts upon a second intermediate wheel 52 mounted via a ball bearing on a vertical arbor 53 of the middle (FIG. 4A). The second intermediate wheel 52 drives a lever 54 mounted via a ball bearing on a vertical arbor 55 of the middle. The curved end 56 of lever 54 is intended to activate control 40 or 41 of the movement 23. The two actuating mechanisms 44, 45 have an identical design that is symmetric relative to a plane of symmetry passing through 3 hours and 9 hours, one 44 actuating the control 40 of start/stop, the other 45 actuating the control 41 of zero reset of the chronograph.

The tilting motion of the mobile part 11 in the two opposite directions is limited by two adjustable stops 60 screwed into the bracket 20 at 6 hours and at 12 hours (FIG. 5).

The amplitude of movement of the levers 56 is limited by set screws 61 mounted onto the middle 21 (FIG. 4B).

The middle 21 is provided with two poising buttons 62 (FIGS. 2 and 6) mounted next to the two pistons 46, and intended to cooperate elastically with recesses 63 provided in bracket 20, in order to stabilise and poise the mobile part 11 in its tilting motion.

The watch moreover comprises a selection mechanism 66 (FIGS. 2 and 7) mounted onto the middle 21 and including a cursor 67 intended to be actuated by the user, and a slide 68 screwed onto the cursor.

The bottom face of slide 68 exhibits a recess 69, and is intended to cooperate with three pins 70, 71, 72 driven into bores of bracket 20 in order to realise a selection of the movements of mobile part (11).

In the middle position illustrated in FIG. 7 none of the pins is in contact with slide 68, hence the mobile part 11 may be swiveled in the two directions in order to control the two chronograph functions of start/stop and zero reset.

With the cursor 67 pushed to the right in FIG. 7, pin 72 on the right is in contact with slide 68, hence the mobile part 11 may only perform a tilting motion counterclockwise about the swivel axis 32. A motion clockwise is inhibited. In this position a control of the start/stop function is possible while control of the zero-reset function is inhibited.

With the curser 67 placed to the left in FIG. 7, pins 70 and 71 are in contact with slide 68, and the mobile part 11 cannot be tilted, hence no control function of the chronograph can be realised.

FIG. 7 in addition shows the entire set of parts of the bracket 20 including the two horn segments 14, 15 screwed into the frame 12 with screws 16. The facing sides 75, 76 of the bracket 20 and mobile part 11 are machined so as to form cylindrical surfaces with a spherical base and very narrow gap allowing a sliding motion of one relative to the other during the tilting motion about the swivel axis 32 constituting the central axis of the cylindrical surfaces.

Referring to FIGS. 8A, 8B and 8C, this tilting motion is barely visible owing to the very narrow gap between the fixed and mobile parts 10, 11.

The control positions of the start/stop function (FIG. 8B) by pressing at 12 hours and of the zero-reset function (FIG. 8C) by pressing at 6 hours are barely distinguishable from the intermediate rest position of the mobile part 11 (FIG. 8A). Through this mechanism of tilting about a well-defined swivel axis 32, one obtains a precise working and a very easy control of the functions even when wearing gloves, while awkward and bulky push-pieces are avoided.

FIGS. 3C and 7 show that the bottom face of the bracket that is facing the wrist of the user exhibits a concave central segment 80 securing elevated wearing comfort. This central segment is surrounded by a peripheral flat segment 81 yielding a stable position of the watch when placed onto a flat support.

It is understood that the embodiment described hereinabove is not of a restricting character, and may receive any modification desired within the scope defined by claim 1. In particular, the controls of the movement may be of any other type, such as those of a repeater, a watch with striking work, a split timer, a timer, a watch with two or more time zones etc. The bracket and the mobile part may be of any other design.

The watch could also exhibit a double bracket with crossed swivel axes admitting a tilting motion about two perpendicular swivel axes. The actuating mechanisms and the selection means could have any other design.

1. Watch including a case (9) and movement (23) fitted with at least one control organ (41, 41) that is accessible from outside the movement and intended to activate at least one function, characterised in that the case (9) comprises a fixed part (10) and a mobile part (11) mounted onto the fixed part so as to be able to swivel about a swivel axis (32), thanks to at least one pivot (31) in order to realise a tilting motion of the mobile part (11) relative to the fixed part (10) while at least one actuating mechanism (44, 45) cooperates with the fixed and mobile parts in order to transform the tilting motion of the mobile part (11) into an action upon said at least one control organ (10, 11), the tilting motion being realised by pressing at least one segment (21, 29) of the mobile part (11).

2. Watch of claim 1, characterised in that the movement (23) comprises a first and a second control organs (40, 41) accessible from outside and intended to activate at least one first and one second functions such as the start/stop and zero-reset functions of a chronograph, the watch including two actuating mechanisms (44, 45) of which a first one (44) and a second one (45), respectively, are arranged so as activate the first (40) and second control organ (41), respectively, while the mobile part (11) performs a tilting motion in a first direction or in a second direction opposite to the first direction, respectively.

3. Watch according to claim 1, characterised in that the fixed part (10) comprises a bracket (20) consisting of two horn pieces (14, 15) and a frame (12), and provided with two pivot segments (31) diametrically opposite, and intended to cooperate with the mobile part (11) so as to enable the tilting motion in two opposite directions.

4. Watch according to claim 3, characterised in that the mobile part (11) comprises a middle (21) mounted pivotingly onto the bracket (20) through the two pivot pieces (31), this middle (21) surrounding the movement (23) and being sealed off by a bottom (22) below and by a bezel (26) and crystal (29) above.

5. Watch according to claim 4, characterised in that said at least one actuating mechanism (44, 45) is mounted into the middle (21) and comprises at least one first element (46) cooperating with the bracket (20) and linked with at least one second element (50, 52, 54) cooperating with said at least one control organ (40, 41) of the movement (23).

6. Watch according to claim 5, characterised in that said first element consists of a piston (46) mounted slidingly into the middle (21), a first end of it cooperating with the bracket (20) and a second end of it cooperating with a first intermediate wheel (50) pivoted about a first arbor (51) of the middle and cooperating with a second intermediate wheel (52) pivoted about a second arbor (53) of the middle and cooperating with a lever (54) pivoted about a third arbor (55) of the middle, one of its ends (56) cooperating with said at least one control organ (40, 41).

7. Watch according to claim 6, characterised in that associated with said piston (46) it comprises a push piston (62) slidingly mounted into the middle (21) and intended to poise the mobile part (11) in its tilting motion.

8. Watch according to claim 4, characterised in that it comprises selection means (66) mounted in mobile fashion onto the mobile part (11) and intended to inhibit a tilting motion of the mobile part (11) in said first and/or second directions while taking up at least one predetermined position.

9. Watch according to claim 8, characterised in that the selection means (66) comprise a slide (68) mounted in mobile fashion onto the middle (21) and including a face intended to cooperate with at least one segment (70, 71, 72) of the bracket (21), the face and segment being shaped so as to allow, either a tilting motion of the mobile part (11) in two opposite directions in a first position of the slide (68), or a tilting motion of the mobile part (11) in just one direction in a second position of the slide (68), or no tilting motion of the mobile part (11) in a third position of the slide (68).

10. Watch according to claim 2, characterised in that the fixed part (10) comprises a bracket (20) consisting of two horn pieces (14, 15) and a frame (12), and provided with two pivot segments (31) diametrically opposite, and intended to cooperate with the mobile part (11) so as to enable the tilting motion in two opposite directions.

11. Watch according to claim 2, characterised in that it comprises selection means (66) mounted in mobile fashion onto the mobile part (11) and intended to inhibit a tilting motion of the mobile part (11) in said first and/or second directions while taking up at least one predetermined position.
